(19) United States
(12) Patent Application Publication
(10) Pub. No.: US 2026/0329162 A1
(43) Pub. Date: Oct. 22, 2026

(54) PROJECTION SLIDE AND PROJECTION DISC

(71) Applicant: Haiyang Zhao, Zhongshan (CN)

(72) Inventor: Haiyang Zhao, Zhongshan (CN)

(21) Appl. No.: 19/553,260

(22) Filed: Feb. 28, 2026

(30) Foreign Application Priority Data
Nov. 28, 2025 (CN) 202522537755.1

(51) Int. Cl. G03B 23/10; G03B 21/00

(52) U.S. Cl. CPC G03B 23/105; G03B 21/001

(57) ABSTRACT

A projection slide and a projection disc are provided. The projection slide includes a carrier plate body and a film sheet. A top part or a bottom part of the carrier plate body is recessed inward to form an accommodation groove; the film sheet is embedded into the accommodation groove; and the carrier plate body is transparent at a position corresponding to the accommodation groove. One side of the film sheet corresponding to an opening of the accommodation groove is coated with Ultraviolet (UV) adhesive; the UV adhesive is configured to seal and fix the film sheet into the accommodation groove; and light can shine through the carrier plate body, the film sheet and the UV adhesive to project a pattern outward.

### TECHNICAL FIELD

The present disclosure relates to the technical field of projection lamps, more particularly to a projection slide and a projection disc.

### BACKGROUND

Existing projection discs generally include a projection disc body, a projection disc upper lid and a film sheet. A top part of the projection disc body is recessed inward to form an upper lid accommodation groove; and a groove bottom of the upper lid accommodation groove is recessed inward to form a film sheet accommodation groove. After the film sheet is embedded into the film sheet accommodation groove, the projection disc upper lid is embedded into the upper lid accommodation groove and is ultrasonically welded to the projection disc body, thereby sealing the film sheet between the projection disc body and the projection disc upper lid. The projection disc body and the projection disc upper lid are both arranged to be transparent at positions corresponding to the pattern of the film sheet, to project outward the pattern on the film sheet.

Compared to the solution of forming holes on the projection disc body and the projection disc upper lid at positions corresponding to the pattern of the film sheet, the above sealing solution can physically isolate the film sheet from heat and dust, delaying the oxidation of the film sheet to some extent and prolonging the service life of the film sheet. However, the above sealing solution is only applicable to the situations with low light source brightness. In the situations with high light source brightness, the above sealing solution also has its drawbacks. First, since the projection disc body and the projection disc upper lid both have some thickness, under the same light source intensity, the projected pattern has less clarity than the solution of the hole-forming solution. Second, if to enhance the clarity, the only way is to increase the light source intensity. Due to the light absorption effect of the film sheet, if the light source intensity is increased, the temperature of the film sheet will rise too. Sine there is no gap between the film sheet and the projection disc body and the projection disc upper lid, the heat of the film sheet dissipates to the outside at a slow rate through the projection disc body and the projection disc, which can accelerate the oxidation of the film sheet and shorten the service life of the film sheet.

### SUMMARY

The present disclosure mainly aims to provide a projection slide and a projection disc, where one side of a film sheet exposed to air is coated with Ultraviolet (UV) adhesive, securely sealing the film sheet into an accommodation groove, meanwhile the UV adhesive is tightly adhered to the film sheet, reducing the thickness of the projection slide and enhancing the brightness and clarity of the projected pattern. Further, the UV adhesive has good heat conductivity, which can achieve heat transfer and physical isolation of dust for the film sheet, delaying the oxidation of the film sheet and greatly prolonging the service life of the projection slide.

To address the above technical problems, the present disclosure provides the following technical solution.

A projection slide includes a carrier plate body and a film sheet; a top part or a bottom part of the carrier plate body is recessed inward to form an accommodation groove; the film sheet is embedded into the accommodation groove; and the carrier plate body is transparent at a position corresponding to the accommodation groove. Specifically, one side of the film sheet corresponding to an opening of the accommodation groove is coated with UV adhesive; the UV adhesive is configured to seal and fix the film sheet into the accommodation groove; and light can shine through the carrier plate body, the film sheet and the UV adhesive to project a pattern outward.

Preferably, a groove bottom of the accommodation groove is coated with UV adhesive to securely adhere the film sheet to the groove bottom of the accommodation groove.

Preferably, an adhesive overflow ring groove is formed on an edge of the groove bottom of the accommodation groove; and during the process of adhering the film sheet to the groove bottom of the accommodation groove, excess UV adhesive can be squeezed into the accommodation groove.

Preferably, the projection slide further includes a pressure ring; when the pressure ring is embedded into the accommodation groove, the pressure ring is pressed onto an edge of the film sheet where no pattern is provided, and the pressure ring is configured to be fixed on a surface of the film sheet by coating of UV adhesive.

The present disclosure further provides a projection slide, including a carrier plate body, a carrier plate upper lid and a film sheet; the film sheet is clamped between the carrier plate body and the carrier plate upper lid; and the carrier plate body and the carrier plate upper lid are both formed with first projection through holes at positions corresponding to a pattern of the film sheet. Specifically, one side of the film sheet corresponding to an opening of the first projection through hole is coated with UV adhesive; the UV adhesive is configured to seal and fix the film sheet between the carrier plate body and the carrier plate upper lid; and light can shine through the first projection through hole, the film sheet and the UV adhesive to project a pattern outward.

Preferably, the projection slide further includes a pressure ring; when the pressure ring is embedded into the first projection through hole of the carrier plate body and/or the first projection through hole of the carrier plate upper lid, the pressure ring is pressed onto a surface of the film sheet where no pattern is provided, and the pressure ring is configured to be fixed on the surface of the film sheet by coating of UV adhesive.

The present disclosure further provides a projection disc, including a projection disc body, further including a projection slide as described above; a top surface of the projection disc body is recessed downward to form a mounting groove; a groove bottom of the mounting groove is formed with a second projection through hole; the projection slide is detachably mounted in the mounting groove; and light can shine through the second projection through hole and the projection slide in sequence to project a pattern outward.

Preferably, a top part or a bottom part of the projection slide is formed with a mounting positioning groove; and one side of the projection slide provided with the mounting positioning groove is mounted in the mounting groove.

The present disclosure has the following beneficial effects.

The present disclosure provides a projection slide and a projection disc. In one type of projection slide, the top part or the bottom part of the carrier plate body is formed with an accommodation groove, one side of the film sheet corresponding to the opening of the accommodation groove is coated with UV adhesive, and the film sheet is sealed and fixed into the accommodation groove through the UV adhesive. With the above scheme, the thickness of the projection slide can be reduced while the brightness and clarity of the projected pattern can be enhanced. Further, due to the sealing function provided by the UV adhesive, the film sheet is tightly adhered to the UV adhesive without being directly exposed to air, whereby the UV adhesive can physically isolate the film sheet from dust while transferring its heat, delaying the oxidation of the film sheet and greatly prolonging the service life of the projection slide. In another type of projection slide, the carrier plate body and the carrier plate upper lid are both formed with first projection through holes at positions corresponding to the pattern of the film sheet, one side of the film sheet corresponding to an opening of the first projection through hole is coated with UV adhesive, and the film sheet is sealed and fixed between the carrier plate body and the carrier plate upper lid through the UV adhesive. With the above scheme, the two first projection through holes can further reduce the thickness of the projection slide, and meanwhile can enhance the brightness and clarity of the projected pattern. Moreover, the UV adhesive can physically isolate the film sheet from dust while transferring its heat, delaying the oxidation of the film sheet and greatly prolonging the service life of the projection slide.

### BRIEF DESCRIPTION OF THE DRAWINGS

For a better understanding of the technical solutions in the embodiments of the present disclosure, accompanying drawings required to be used in the description of the embodiments are simply illustrated below. Apparently, the accompanying drawings described below are some embodiments of the present disclosure merely. For the ordinary skill in the field, other accompanying drawings may be obtained without creative effort according to these accompanying drawings, which are all included in the scope of protection of the present disclosure and in which:

FIG. 1 is a structure diagram of a projection slide according to Embodiment 1 of the present disclosure.

FIG. 2 is a sectional view of the projection slide shown in FIG. 1.

FIG. 3 is an exploded view of the projection slide shown in FIG. 1.

FIG. 4 is an exploded view of a projection disc according to Embodiment 1 of the present disclosure.

FIG. 5 is a structure diagram of a projection slide according to Embodiment 2 of the present disclosure.

FIG. 6 is a sectional view of the projection slide shown in FIG. 5.

FIG. 7 is an exploded view of the projection slide shown in FIG. 5.

FIG. 8 is an exploded view of a projection disc according to Embodiment 2 of the present disclosure.

### DETAILED DESCRIPTION OF THE EMBODIMENTS

The technical solutions of the embodiments of the present disclosure will be clearly and completely described below. Apparently, the described embodiments are merely part embodiments of the present disclosure, rather than all of the embodiments. All of the other embodiments that a person skilled in the art obtains on the basis of the embodiments of the present disclosure without paying creative work are intended to fall within the protection scope of the present disclosure.

In the description of the present disclosure, unless otherwise specifically stated and defined, terms such as “arranged”, “mounted”, “interconnected”, “connected”, etc. should be interpreted expansively. For example, they may be fixed connection, also may be rotatable connection, or integration; may be mechanical connection, also may be electrical connection; may be direct connection, also may be indirect connection through an intermediate, and may be internal communication between two elements. The ordinary skill in this field can understand the specific implication of the above terms in the present disclosure in accordance with specific conditions.

Existing projection discs generally include a projection disc body, a projection disc upper lid and a film sheet. A top part of the projection disc body is recessed inward to form an upper lid accommodation groove; and a groove bottom of the upper lid accommodation groove is recessed inward to form a film sheet accommodation groove. After the film sheet is embedded into the film sheet accommodation groove, the projection disc upper lid is embedded into the upper lid accommodation groove, thereby sealing the film sheet between the projection disc body and the projection disc upper lid. The projection disc body and the projection disc upper lid are both arranged to be transparent at positions corresponding to the pattern of the film sheet, to project outward the pattern on the film sheet.

Compared to the solution of forming holes on the projection disc body and the projection disc upper lid at positions corresponding to the pattern of the film sheet, the sealing solution can isolate the film sheet from heat and dust, meanwhile delay the oxidation of the film sheet and prolong the service life of the film sheet. However, the sealing solution also has its drawbacks. Since the projection disc body and the projection disc upper lid both have some thickness, under the same light source intensity, the projected pattern has less clarity than the solution of the hole-forming solution. If to enhance the clarity, the only way is to increase the light source intensity, which can further increase the temperature of the whole projection disc.

### Embodiment 1

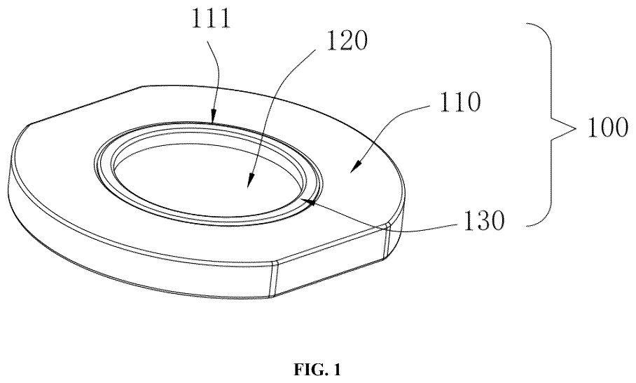

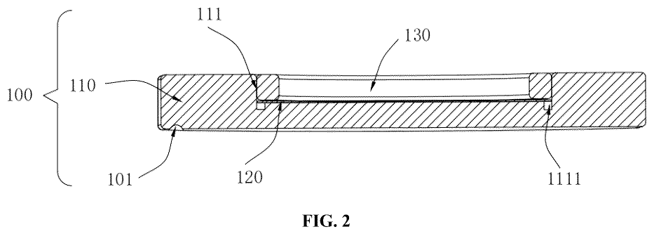

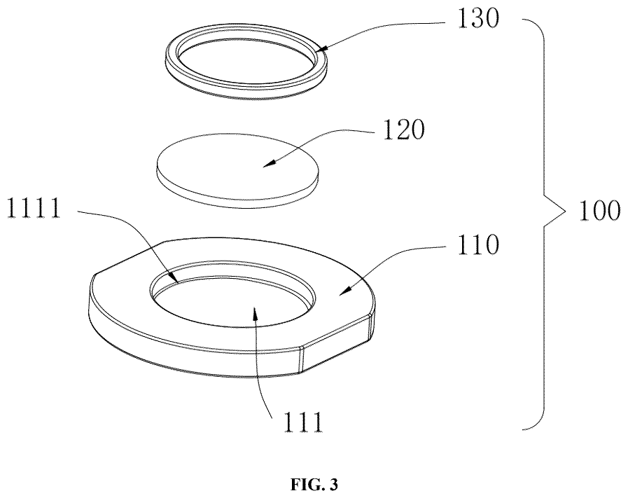

As shown in FIG. 1, FIG. 2 and FIG. 3, Embodiment 1 of the present disclosure provides a projection slide 100, including a carrier plate body 110 and a film sheet 120. A top part or a bottom part of the carrier plate body 110 is recessed inward to form an accommodation groove 111; the film sheet 120 is embedded into the accommodation groove 111; and the carrier plate body 110 is transparent at a position corresponding to the accommodation groove 111.

Specifically, one side of the film sheet 120 corresponding to an opening of the accommodation groove 111 is coated with UV adhesive (not shown in the figures). The UV adhesive (not shown in the figures) is configured to seal and fix the film sheet 120 into the accommodation groove 111; and light can shine through the carrier plate body 110, the film sheet 120 and the UV adhesive to project a pattern outward.

In the present disclosure, with the above scheme, the top part or the bottom part of the carrier plate body 110 is formed with an accommodation groove 111, one side of the film sheet 120 corresponding to an opening of the accommodation groove 111 is coated with UV adhesive (not shown in the figures), and the film sheet 120 is sealed into the accommodation groove 111 through the UV adhesive (not shown in the figures), thus the thickness of the projection slide 100 can be reduced while the brightness and clarity of the projected pattern can be enhanced. Moreover, due to the sealing function provided by the UV adhesive (not shown in the figures), the film sheet is not directly exposed to air, whereby the UV adhesive (not shown in the figures) can isolate the film sheet 120 from heat and dust, and meanwhile can delay the oxidation of the film sheet 120 and greatly prolong the service life of the film sheet 100.

To enhance the fitness between the film sheet 120 and the accommodation groove 111, a groove bottom of the accommodation groove 111 is coated with UV adhesive (not shown in the figures) to securely adhere the film sheet 120 to the groove bottom of the accommodation groove 111, whereby tiny gaps between the film sheet 120 and the accommodation groove 111 can be filled by the UV adhesive (not shown in the figures), further enhancing the fitness between the film sheet 120 and the accommodation groove 111, and further enhancing the heat dissipation capability of the film sheet 120.

To enhance the adhesion flatness of the film sheet 120 to the groove bottom of the accommodation groove 111, an adhesive overflow ring groove 1111 is formed on an edge of the groove bottom of the accommodation groove 111. During the process of adhering the film sheet 120 to the groove bottom of the accommodation groove 111, the excess UV adhesive (not shown in the figures) can be squeezed into the accommodation groove 111, avoiding the occurrence that the excess UV adhesive (not shown in the figures) is accumulated between the film sheet 120 and the accommodation groove 111 to cause unevenness of the film sheet 120 when adhered to the groove bottom of the accommodation groove 111.

To prevent the edge of the film sheet 120 being curled up and to enhance the flatness of the film sheet 120, the projection slide 100 further includes a pressure ring 130. When the pressure ring 130 is embedded into the accommodation groove 111, the pressure ring 130 is pressed onto an edge of the film sheet 120 where no pattern is provided, and the pressure ring 240 is configured to be fixed on a surface of the film sheet 120 by coating of UV adhesive (not shown in the figures), whereby the edge of the film sheet 120 can be pressed down by the pressure ring 130, avoiding the edge of the film sheet 120 being curled up, meanwhile the UV adhesive (not shown in the figures) solidified within the inner space of the pressure ring 130 can also press down the middle part of the film sheet 120, keeping the flatness of the film sheet 120.

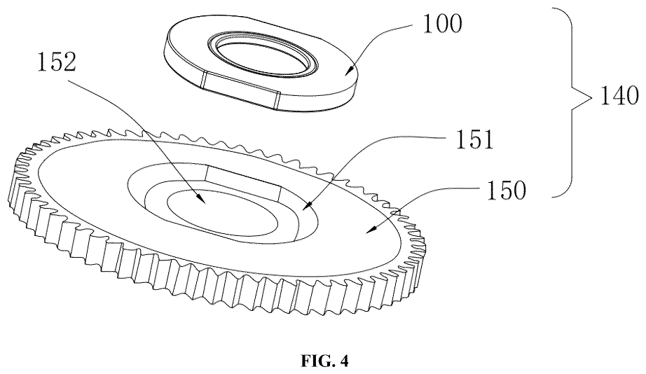

As shown in FIG. 4, the present disclosure provides a projection disc 140, including a projection disc body 150, further including a projection slide 100 as described above. A top surface of the projection disc body 150 is recessed downward to form a mounting groove 151; a groove bottom of the mounting groove 151 is formed with a second projection through hole 152; and the projection slide 100 is detachably mounted in the mounting groove 151. Light can shine through the second projection through hole 152 and the projection slide 100 in sequence to project a pattern outward. With the above scheme, the projection slide 100 is replaceable, which is convenient and quick to replace. When a user becomes bored with the content of the projection slide 100 or when the projection slide 100 is damaged, the content of projection can be changed or the projection disc 140 can be maintained by replacing the projection slide 100.

To locate the mounting direction of the projection slide 100, a top part or a bottom part of the projection slide 100 is formed with a mounting positioning groove 101, and one side of the projection slide 100 provided with the mounting positioning groove is mounted in the mounting groove 151, thereby facilitating identification of which side of the projection slide 100 is mounted in the mounting groove 151.

### Embodiment 2

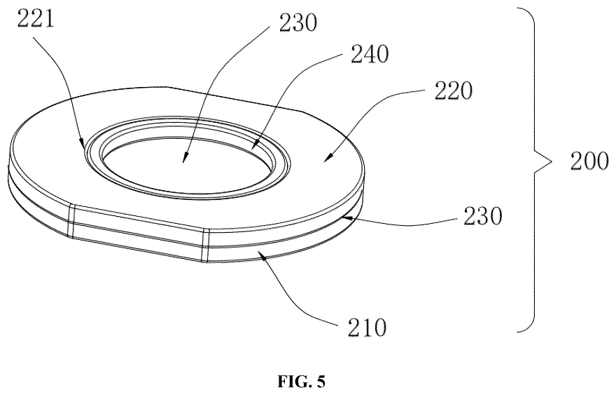

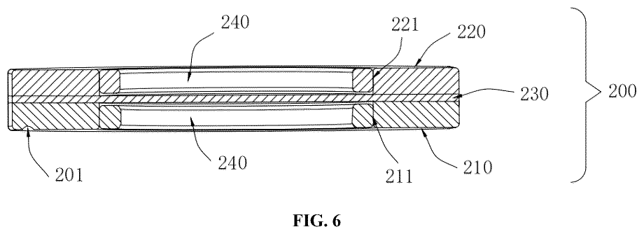

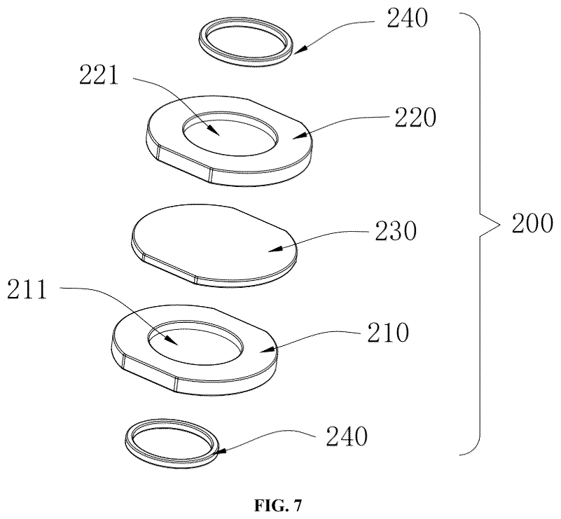

As shown in FIG. 5, FIG. 6 and FIG. 7, Embodiment 2 of the present disclosure provides a projection slide 200, including a carrier plate body 210, a carrier plate upper lid 220 and a film sheet 230. The film sheet 230 is clamped between the carrier plate body 210 and the carrier plate upper lid 220; the carrier plate body 210 and the carrier plate upper lid 220 are both formed with first projection through holes 211, 221 at positions corresponding to a pattern of the film sheet 230.

One side of the film sheet 230 corresponding to an opening of the first projection through holes 211, 221 is coated with UV adhesive (not shown in the figures). The UV adhesive (not shown in the figures) is configured to seal and fix the film sheet 230 between the carrier plate body 210 and the carrier plate upper lid 220. Light can shine through the first projection through holes 211, 221, the film sheet 230 and the UV adhesive to project a pattern outward.

In the present disclosure, with the above scheme, the carrier plate body 210 and the carrier plate upper lid 220 are formed with the first projection through holes 211, 221, where the two first projection through holes 211, 221 can further reduce the thickness of the projection slide 200, and meanwhile can enhance the brightness and clarity of the projected pattern. Moreover, the UV adhesive (not shown in the figures) can isolate the film sheet 230 from heat and dust, and meanwhile can delay the oxidation of the film sheet 230 and greatly prolong the service life of the film sheet 200.

To prevent the edge of the film sheet 230 being curled up and to enhance the flatness of the film sheet 230, the projection slide 200 further includes a pressure ring 240. When the pressure ring 240 is embedded into the first projection through hole 211 of the carrier plate body 210 and/or the first projection through hole 221 of the carrier plate upper lid 220, the pressure ring 240 is pressed onto a surface of the film sheet 230 where no pattern is provided, that is to say, the pressure ring 240 can be embedded into the first projection through hole 211 of the carrier plate body 210 or the first projection through hole 221 of the carrier plate upper lid 220 separately or both the first projection through hole 211 of the carrier plate body 210 and the first projection through hole 221 of the carrier plate upper lid 220 are embedded with the pressure rings 240. The pressure ring 240 is configured to be fixed on the surface of the film sheet 230 by coating of UV adhesive (not shown in the figures). In this way, the edge of the film sheet 230 at the first projection through holes 211, 221 can be pressed down by the pressure ring 240, avoiding the edge of the film sheet 230 at the first projection through holes 211, 221 being curled up, meanwhile the UV adhesive (not shown in the figures) solidified within the inner space of the pressure ring 240 can also press down the middle part of the film sheet 230, keeping the flatness of the film sheet 230.

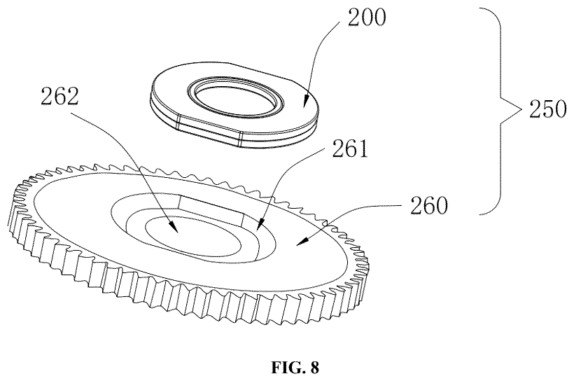

As shown in FIG. 8, the present disclosure further provides a projection disc 250, including a projection disc body 260, further including a projection slide 200 as described above. A top surface of the projection disc body 260 is recessed downward to form a mounting groove 261; a groove bottom of the mounting groove 261 is formed with a second projection through hole 262; and the projection slide 200 is detachably mounted in the mounting groove 261. Light can shine through the second projection through hole 262 and the projection slide 200 in sequence to project a pattern outward. That is, light shines through the second projection through hole 262 of the projection disc body 260, the first projection through hole 211 of the carrier plate body, the UV adhesive (not shown in the figures), the film sheet 230, the UV adhesive (not shown in the figures), and the first projection through hole 221 of the carrier plate upper lid 220 in sequence to project a pattern outward.

To locate the mounting direction of the projection slide 200, a top part or a bottom part of the projection slide 200 is formed with a mounting positioning groove 201, and one side of the projection slide 200 provided with the mounting positioning groove 201 is mounted in the mounting groove 261, thereby facilitating identification of which side of the projection slide 200 is mounted in the mounting groove 261.

The present disclosure has been described above in detail with reference to the accompanying drawings, but it is not limited to the described embodiments. For those skilled in the art, various changes, modifications, substitutions and variations can be made to these embodiments without departing from the principle and spirit of the present disclosure, and they shall still fall within the scope of protection of the present disclosure.

What is claimed is:

1. A projection slide, comprising a carrier plate body and a film sheet, wherein a top part or a bottom part of the carrier plate body is recessed inward to form an accommodation groove, the film sheet being embedded into the accommodation groove, and the carrier plate body being transparent at a position corresponding to the accommodation groove; and
wherein one side of the film sheet corresponding to an opening of the accommodation groove is coated with Ultraviolet (UV) adhesive, the UV adhesive being configured to seal and fix the film sheet into the accommodation groove, wherein light can shine through the carrier plate body, the film sheet and the UV adhesive to project a pattern outward.

2. The projection slide according to claim 1, wherein a groove bottom of the accommodation groove is coated with UV adhesive to securely adhere the film sheet to the groove bottom of the accommodation groove.

3. The projection slide according to claim 2, wherein an adhesive overflow ring groove is formed on an edge of the groove bottom of the accommodation groove, and wherein during the process of adhering the film sheet to the groove bottom of the accommodation groove, excess UV adhesive can be squeezed into the accommodation groove.

4. The projection slide according to claim 1, further comprising a pressure ring, wherein when the pressure ring is embedded into the accommodation groove, the pressure ring is pressed onto an edge of the film sheet where no pattern is provided, and wherein the pressure ring is configured to be fixed on a surface of the film sheet by coating of UV adhesive.

5. A projection slide, comprising a carrier plate body, a carrier plate upper lid and a film sheet, wherein the film sheet is clamped between the carrier plate body and the carrier plate upper lid, the carrier plate body and the carrier plate upper lid being both formed with first projection through holes at positions corresponding to a pattern of the film sheet; and
wherein one side of the film sheet corresponding to an opening of the first projection through hole is coated with UV adhesive, the UV adhesive being configured to seal and fix the film sheet between the carrier plate body and the carrier plate upper lid, and wherein light can shine through the first projection through hole, the film sheet and the UV adhesive to project a pattern outward.

6. The projection slide according to claim 5, further comprising a pressure ring, wherein when the pressure ring is embedded into the first projection through hole of the carrier plate body and/or the first projection through hole of the carrier plate upper lid, the pressure ring is pressed onto a surface of the film sheet where no pattern is provided, and wherein the pressure ring is configured to be fixed on the surface of the film sheet by coating of UV adhesive.

7. A projection disc, comprising a projection disc body, further comprising the projection slide according to claim 1, wherein
a top surface of the projection disc body is recessed downward to form a mounting groove, a groove bottom of the mounting groove being formed with a second projection through hole, and the projection slide being detachably mounted in the mounting groove; and wherein light can shine through the second projection through hole and the projection slide in sequence to project a pattern outward.

8. The projection disc according to claim 7, wherein a top part or a bottom part of the projection slide is formed with a mounting positioning groove, and wherein one side of the projection slide provided with the mounting positioning groove is mounted in the mounting groove.
